(19) United States
(12) Patent Application Publication
(10) Pub. No.: US 2016/0142826 A1
(43) Pub. Date: May 19, 2016

(54) VOICE COIL UNIT, ELECTRO-ACOUSTIC TRANSDUCER, AND HEADPHONE SET

(71) Applicants: Yoji HONDA, Tokyo (JP); Kenzo TSUIHIJI, Tokyo (JP); Koichiro TANOUE, Tokyo (JP); Kenji ARAI, Tokyo (JP)

(72) Inventors: Yoji HONDA, Tokyo (JP); Kenzo TSUIHIJI, Tokyo (JP); Koichiro TANOUE, Tokyo (JP); Kenji ARAI, Tokyo (JP)

(73) Assignee: KABUSHIKI KAISHA AUDIO-TECHNICA, Tokyo (JP)

(21) Appl. No.: 14/934,497

(22) Filed: Nov. 6, 2015

(30) Foreign Application Priority Data
Nov. 18, 2014 (JP) 2014-233915

(51) Int. Cl. H04R 9/04; H04R 1/24; H04R 1/10

(52) U.S. Cl. CPC H04R 9/046; H04R 1/1008; H04R 1/24; H04R 2209/041

(57) ABSTRACT

A voice coil unit for a dynamic electro-acoustic transducer is disposed in a magnetic circuit, outputs acoustic waves through driving of a diaphragm in response to digital signals, and includes coils that are each composed of a multi-strand wire and receive different digital signals.

### TECHNICAL FIELD

The present invention relates to a voice coil unit, an electro-acoustic transducer including the voice coil unit, and a headphone set.

### BACKGROUND ART

A typical dynamic electro-acoustic transducer in an audio speaker or a headphone set includes a voice coil fixed to a diaphragm disposed in a magnetic gap.

The dynamic electro-acoustic transducers outputs acoustic waves through vibration of the diaphragm depending on amplitude and/or frequency of analog electrical signals passing through the voice coil. Digital signals from a sound source applied to the voice coil is converted to analog signals through a digital-to-analog converter disposed between the sound source and the electro-acoustic transducer. Without such conversion, the digital signals from the sound source cannot be output as acoustic waves.

A signal converter that outputs acoustic waves in response to direct application of digital signals from a sound source without conversion to analog signals is described, for example, in Japanese Patent Publication No. 4883428.

An electro-acoustic transducer including a signal converter according to Japanese Patent Publication No. 4883428 requires multiple voice coils in a voice coil unit for a single diaphragm. The voice coils receive different digital signals.

A typical voice coil unit is a wire wound into the form of a coil. The wire is composed of copper, aluminum, or any other conductive metal. The driving force of the diaphragm increases in proportion to the number of turns of the wire. The wire can be wound in different styles. For example, in “single-layer winding,” the wire is wound without overlap, whereas in “multilayer winding,” the wire is wound with overlap to form layers of inner and outer turns.

The driving force of the diaphragm is determined by the relationship between the voice coil unit and the magnetic flux in a magnetic gap. The driving force of the diaphragm can be increased by disposing many turns of the coil in the magnetic flux. An increase in the driving force of the diaphragm enhances the quality of reproduced input signals. The volume of the magnetic gap is limited. If a single-layer voice coil unit is disposed inside the magnetic gap, the number of turns of the voice coil unit and the impedance component can be readily controlled but the volume and the winding width of the wire inside the magnetic gap cannot be readily increased. If a multilayer voice coil unit is disposed inside the magnetic gap, the winding width of the voice coil unit can be readily controlled but the DC resistance component varies due to a difference in length between the inner and outer turns. Thus, in the multilayer winding, the DC resistance component should be controlled through the numbers of inner and outer turns. This requires complicated adjustment of the number of turns in individual layers.

If a voice coil unit composed of a single wire and a voice coil unit composed of a plural number of wire are adjusted to have the same DC resistance component, the inductance component of the plural number of wires is smaller than that of the single wire.

In an electro-acoustic transducer including multiple conventional voice coils in a voice coil unit for a single diaphragm, as described above, its impedance increases in response to an increase in high-frequency components of the input signals. Large high-frequency components in the input signals cause a skin effect, which causes a decrease in the effective cross-section and an increase in the DC resistance components. The driving force of the diaphragm decreases due to increases in impedance and DC resistance. A decrease in the driving force of the diaphragm causes a decrease in the quality of reproduced input signals.

### SUMMARY OF INVENTION

### Technical Problem

Digital signals pass through a voice coil unit in an electro-acoustic transducer including a signal converter such as that according to Japanese Patent Publication No. 4883428. Digital signals have a rectangular waveform and thus include more high-frequency components than those in analog signals. That is, a diaphragm including a conventional voice coil unit for analog signals reproduces low-quality high-frequency components, in particular. Furthermore, the voice coil unit includes multiple voice coils disposed on a single diaphragm and thus has an increased winding width with single-layer winding, and requires complicated adjustment of the number of turns with multilayer winding. Thus, conventional voice coil units cannot readily prevent a decrease in the driving force of the diaphragm due to high-frequency components.

An object of the present invention is to provide a voice coil unit for an electro-acoustic transducer that (i) includes multiple voice coils disposed on a single diaphragm, (ii) generates a sufficient driving force of the compact diaphragm, and (iii) can effectively generate signals in high-frequency regions. Another object of the present invention is to provide an electro-acoustic transducer including such a voice coil unit.

### Solution to Problem

The present invention provides a voice coil unit for a dynamic electro-acoustic transducer that is disposed in a magnetic circuit, outputs acoustic waves through driving of a diaphragm in response to digital signals, and includes multiple coils, which are each composed of a multi-strand wire and receive different digital signals.

### Advantageous Effects of Invention

The voice coil unit according to the present invention can generate a sufficient driving force in a compact diaphragm, and thus can effectively generate signals in high-frequency regions.

### BRIEF DESCRIPTION OF DRAWINGS

FIG. 1 is a perspective view illustrating an example electro-acoustic transducer according to the present invention.

FIG. 2 is a perspective cross-sectional view illustrating an example driving unit including the electro-acoustic transducer.

FIG. 3 is a perspective view illustrating an example voice coil unit in the driving unit.

FIG. 4 is a partially enlarged perspective view illustrating the voice coil unit.

FIG. 5 is a functional block diagram illustrating an example configuration of the electro-acoustic transducer.

### DESCRIPTION OF EMBODIMENTS

Embodiments of a voice coil unit, an electro-acoustic transducer, and a headphone set according to the present invention will now be described with reference to the accompanying drawings.

Electro-Acoustic Transducer

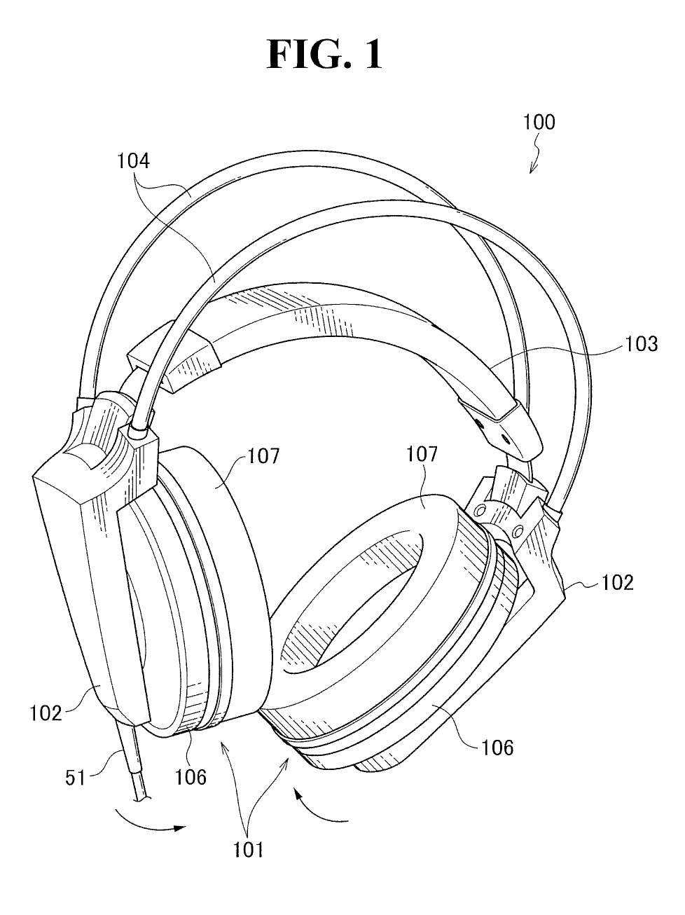

With reference to FIG. 1, a headphone set 100 includes right and left headphone units 101, which each include a dynamic electro-acoustic transducer or driver unit 10 described below. Each of the headphone units 101 is supported on a support 102 connected to each end of a longitudinally curved head pad 103. The headphone unit 101 includes an ear pad 107 that is to come into contact with an ear region of a user and a housing 106 that is attached to the ear pad 107. The outer shape of the contact surface of the ear pad 107 is a substantial oval that covers the ear region of the user. The outer shape of the housing 106 is also a substantial oval that is the same as that of the ear pad 107. Alternatively, the housing 106 and the ear pad 107 may have any other outer shape. In such a case, the outer shape may be a typical substantial circle or a polygon.

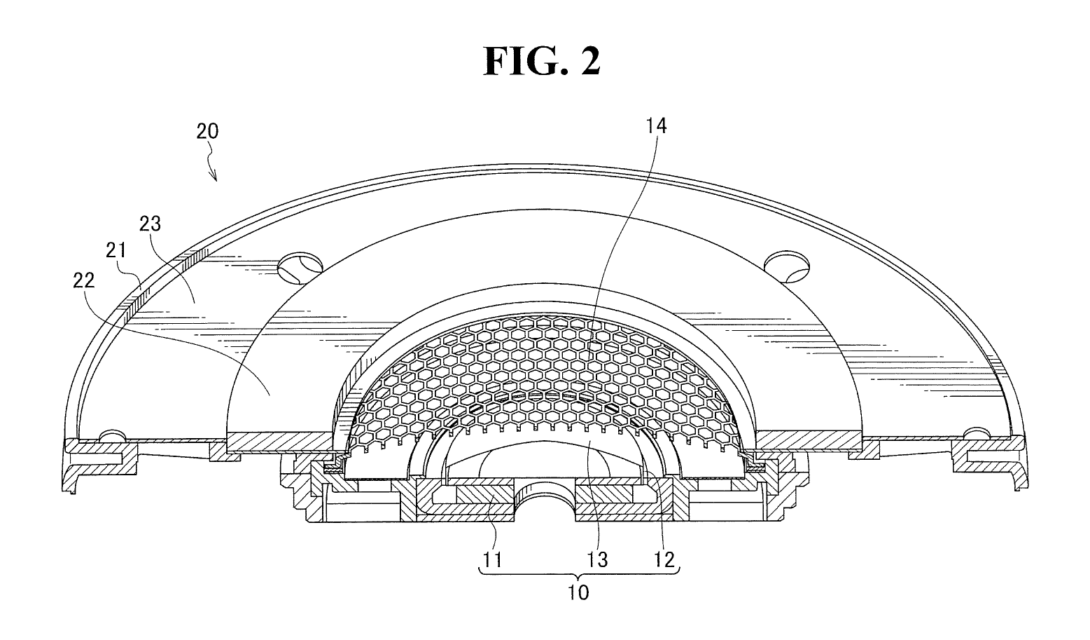

The housing 106 accommodates the driver unit 10, which converts electric signals to acoustic waves. FIG. 2 is a cross-sectional perspective view of the driver unit 10 in the headphone unit 101 in the output direction of acoustic waves.

With reference to FIG. 2, the driver unit 10 includes a magnet 11 that constitutes a magnetic circuit that generates a magnetic field, a voice coil unit 12 disposed in a magnetic gap in the magnetic field generated by the magnet 11, and a diaphragm 13 that is attached to the voice coil unit 12. The voice coil unit 12 vibrates the diaphragm 13 in the anteroposterior direction in response to input electric signals. A protector 14 is disposed on the front of the driver unit 10 and protects the diaphragm 13 and other components. The protector 14 has multiples holes through which audio signals pass.

The driver unit 10 is attached to a baffle 20. The driver unit 10 is fixed to the interior of the housing 106 with the baffle 20. The baffle 20 includes a first acoustic filter 22, a second acoustic filter 23, and any other component on the front face.

Referring now back to FIG. 1, the support 102 has an interior space accommodating a signal processor circuit 201, which will be described below. The signal processor circuit 201 is disposed in the interior space of the support 102 of one of the right and left housings 106. An interface connected to a signal input line or first signal line (connecting cable 51) from the sound source is disposed below the support 102 accommodating the signal processor circuit 201.

The two supports 102 supporting the respective housings 106 are connected to the right and left ends, respectively, of the head pad 103. The supports 102 are also connected to each other with resilient curved bars 104. The ends of the curved bars 104 are attached to the front and back upper edge portions of the supports 102. The curved bars 104 generate lateral pressure during use of the headphone set 100. The curved bars 104 also function as a headband. In this embodiment, a second signal line described below is disposed inside the curved bars 104. In place of the curved bars 104, a resilient head pad 103 may be used to apply lateral pressure. In such a case, the head pad 103 also functions as a headband.

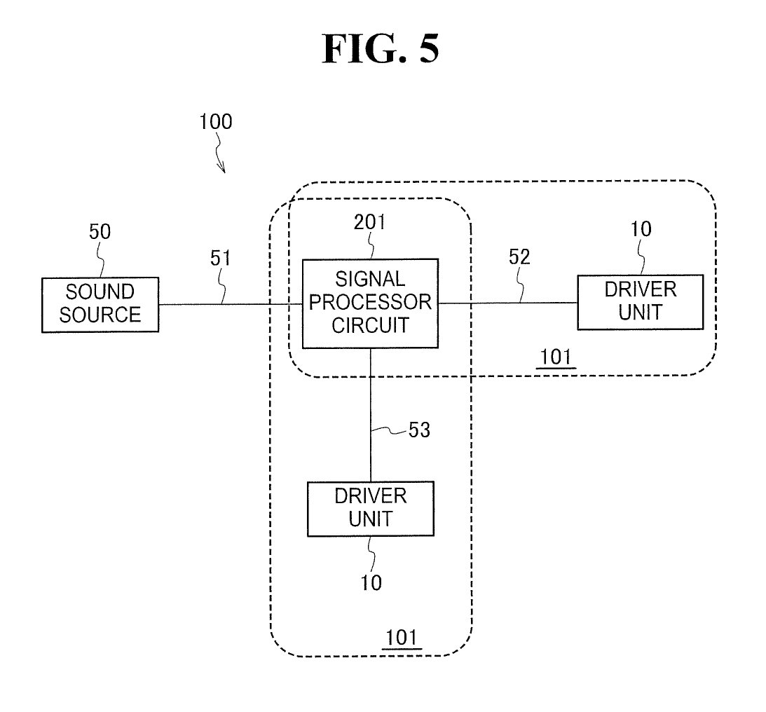

The function of the headphone units 101 in the headphone set 100 will now be described. With reference to FIG. 5, the headphone units 101 include the driver units 10 and shares the signal processor circuit 201. As described above, each driver unit 10 includes a voice coil unit 12 disposed in a magnetic gap and a diaphragm 13 that vibrates in response to electric signals applied to the voice coil unit 12.

The vibration of the diaphragm 13 converts electric signals to acoustic waves. The signals applied to the driver unit 10 are digital signals. Multiple coils of the voice coil unit 12 are fixed to the single diaphragm 13.

The digital signals applied to the voice coil unit 12 are modulated signals of output from a sound source 50 through a predetermined signal modulation process. Even if pulse-code modulated (PCM) digital signals are output from the sound source 50, the digital signals applied to the voice coil unit 12 in the corresponding driver unit 10 are not PCM signals. The digital signals applied to the diaphragm 13 are pulse-density modulated (PDM) signals, for example. Hereinafter, the digital signals applied to the voice coil unit 12 are PDM signals.

The signal processor circuit 201 is connected to a digital sound source 50 via a first signal line or connecting cable 51. The driver unit 10 in the headphone unit 101 including the signal processor circuit 201 is electrically connected to the signal processor circuit 201 via a signal cable 53. The driver unit 10 in the headphone unit 101 not including the signal processor circuit 201 is electrically connected to the signal processor circuit 201 via a jumper cable 52 disposed along the head pad 103.

The voice coil unit 12 in the driver unit 10 includes, for example, four coils, which are fixed to the single diaphragm 13. Each coil of the voice coil unit 12 receives a separate digital signal processed at the signal processor circuit 201. In other words, different digital signals are input to these coils of the voice coil unit 12. Two signal lines are required for each coil in the voice coil unit 12 for connection between the signal processor circuit 201 and the corresponding coil. One of the signal lines is a positive lead, and the other is a negative lead. The pair of positive and negative leads is provided for each coil in the voice coil unit 12 so as to serve as the signal cable 53 or the jumper cable 52. Headphone unit 101 generates sound wave from directly input the digital signals. That is, the headphone unit 101 in this embodiment is for digital signal input only.

### Voice Coil Unit

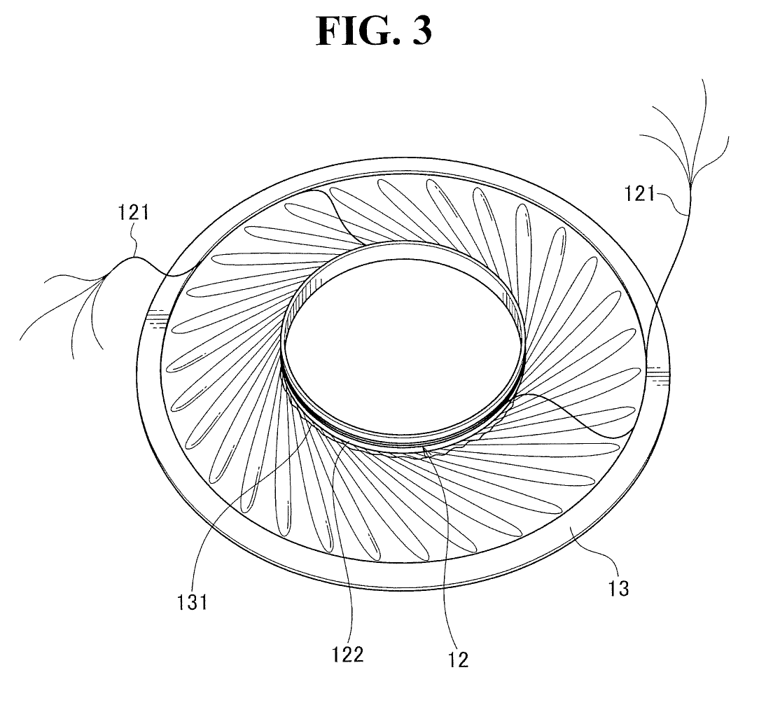

A voice coil unit according to an embodiment of the present invention will now be described. FIG. 3 is a perspective view illustrating the diaphragm 13 and the voice coil unit 12 in the driver unit 10. With reference to FIG. 3, the voice coil unit 12 is disposed at the substantial center of the discoidal diaphragm 13 and includes a voice coil wire 121 wound around a winding core 122.

The voice coil wire 121 is composed of an insulated conductor, such as copper or aluminum. The voice coil wire 121 has a stranded structure consisting of a multi-strand wire. Each of the plurality of the voice coil wires composing the voice coil wire 121 are either a solid wire, or a stranded wire. As described above, the voice coil unit 12 includes four coils. That is, the voice coil unit 12 is composed of a voice coil wire 121, which comprises a four-strand wire. Each of the four-strand wires may be composed of either a solid wire or a stranded wire.

The wire used for conventional voice coil units is solid wire. The voice coil unit 12 according to this embodiment should generate substantially identical driving forces at all coils that receive different digital signals from the signal processor circuit 201. Thus, the voice coil unit 12 should include coils that have the same number of turns and be composed of wires having the same length and width.

The voice coil unit 12 is composed of a voice coil wire 121 composed of a multi-strand wire consisting of the same number of strands as the number of coils.

Both ends of the voice coil wire 121 are separated to expose the ends of the four-strand wire so as to serve as coil leads. Both ends of each coil lead of the voice coil wire 121 are connected to the positive and negative leads of the signal cable 53 and the jumper cable 52. In this way, different digital signals can be input to the four coils in the voice coil unit 12. In this embodiment, the diaphragm 13 is driven to generate acoustic waves corresponding to a combination of digital signals input to the four coils in the voice coil unit 12. The amplitude and the vibration frequency of the diaphragm 13 are controlled in accordance with the combination of digital signals input to the four coils. Through such control, the diaphragm 13 converts the digital signals to vibration so as to radiate acoustic waves into the atmosphere.

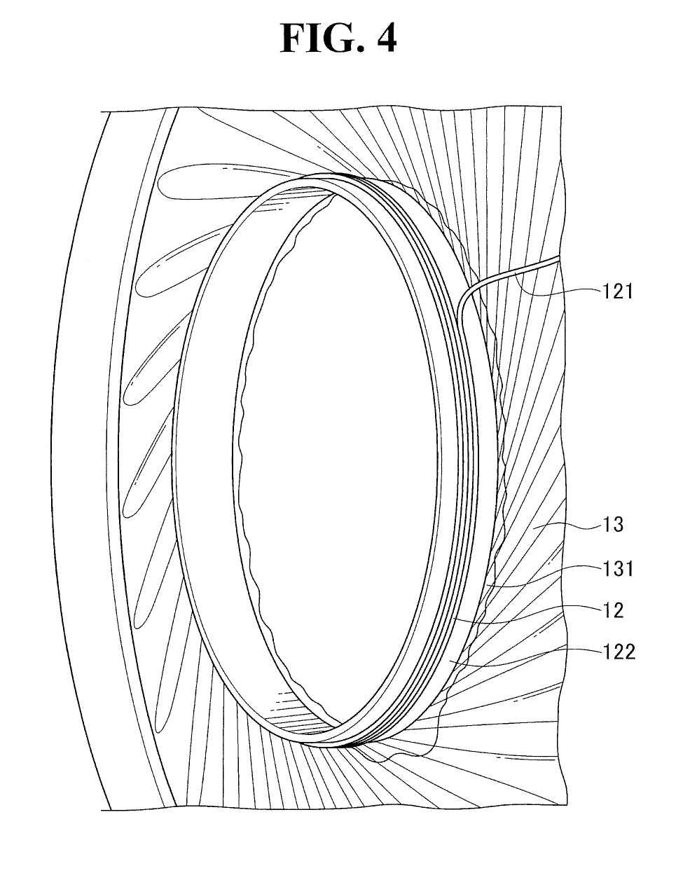

With reference to FIG. 4, the voice coil wire 121 of the voice coil unit 12 is wound around the winding core 122 in the multilayer winding. The winding core 122 is fixed to the central area of the thin discoidal diaphragm 13 with an adhesive 131 such that the outer circumference of the voice coil unit 12 is equidistance from the outer circumference of the diaphragm 13. In this embodiment, the voice coil wire 121 is wound in double layers. Alternatively, the voice coil wire 121 may be disposed in a single layer or three or more layers.

The voice coil unit 12 is composed of a voice coil wire 121, which consists of a four-strand wire. Alternatively, the voice coil wire 121 may be a multi-strand wire composed of two-strand wire.

The impedance of the voice coil unit 12 including coils composed of a four-strand voice coil wire 121 is adjusted to the same impedance as the voice coil unit 12 which in composed of a voice coil wire.

### Advantageous Effects

The voice coil unit 12 is composed of a four-strand voice coil wire 121 and thus has a smaller inductance component as compared with conventional ones. The voice coil unit 12 can also reduce the skin effect. This eliminates factors that lower the quality of reproduced high-band signals. The quality of the sound reproduction is enhanced particularly in a driving mode based on digital signals (rectangular signals) including high-frequency components.

A small inductance component and weak skin effect can maintain the driving force in high-frequency regions, unlike in conventional voice coil structures, and enhance the quality of reproduced signals in the high-frequency regions. The stranded structure of the voice coil wire 121 provides strong inter-strand bonding that prevents separation of the strands. Thus, the coils of the voice coil unit 12 have a minimum manufacturing variation. The coils of the voice coil unit 12 having substantially the same characteristics in response to different signals can function as a digitally driven electro-acoustic transducer that can reproduce sound at high quality.

What is claimed is:

1. A voice coil unit for a dynamic electro-acoustic transducer disposed in a magnetic circuit and outputs acoustic waves through driving of a diaphragm in response to digital signals, the voice coil unit comprising:
a plurality of coils receiving different digital signals,
each of the coils being composed of a multi-strand wire.

2. A dynamic electro-acoustic transducer comprising:
a diaphragm; and
a voice coil unit fixed to the diaphragm,
the voice coil unit comprising the voice coil unit according to claim 1.

3. A headphone set comprising:
two driver units;
a longitudinally curved headband, the ends of the headband being attached to the driver units; and
the electro-acoustic transducer according to claim 2 electrically connected to the head phone via a line disposed along the headband and attached to the driver units.
